(19) United States
(12) Patent Application Publication
(10) Pub. No.: US 2007/0279511 A1
(43) Pub. Date: Dec. 6, 2007

(54) Image capture apparatus

(75) Inventor: Atsushi Misawa, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/798,842

(22) Filed: May 17, 2007

(30) Foreign Application Priority Data
May 17, 2006 (JP) 2006-137987

(51) Int. Cl. H04N 5/222

(52) U.S. Cl. 348/333.06

(57) ABSTRACT

A digital camera is constituted of a main body and an image display unit which is selectively and removably attached to a front or a rear surface of the main body. When the image display unit is attached to the rear surface, a first menu screen is displayed on an LCD of the image display unit, and operation modes are limited to a still image capture mode, a movie capture mode, and a reproduction mode. When the image display unit is attached to cover the entire front surface, a second menu screen is displayed on the LCD, and the operation modes are limited to an image viewer mode and a music player mode. When the image display unit is attached to a position close to a lateral surface on the front surface, a taking lens is exposed, and the digital camera is set to a self capture mode.

### FIELD OF THE INVENTION

The present invention relates to an image capture apparatus such as a digital camera, a mobile phone with a camera, and the like.

### BACKGROUND OF THE INVENTION

Digital cameras and mobile phones with cameras are widely used as image capture apparatuses. Among such image capture apparatuses, there are multi-functional image capture apparatuses used as an image viewer for reproducing images, or a music player for reproducing music, by receiving video, still images, sound, and/or music from a personal computer.

An image capture apparatus which protects an electronic display element in non-operating state is known (see Japanese Patent Laid-Open Publication No. 09-043716). The image capture apparatus has a silver salt image capture device which captures a subject image entered through an optical system on a film, an electronic image capture device which converts a subject image entered through the optical system into an image signal and records the converted image signal in a recording medium, an electronic display element for displaying an image output from the electronic image capture device and other information, and a device for protecting the electronic display element in non-operating state.

An electronic camera having a main body constituted of an insertion part and a covering part is known (see Japanese Patent Laid-Open Publication No. 2000-338551). The insertion part, other than its top surface and knob parts, is inserted in the covering part when the electronic camera is carried. The insertion part is retained in the covering part and slides up and down, and is pulled out from the covering part when the electronic camera is in use. An imaging optical system, a viewfinder optical system, a light metering section, a mode selection switch, a selection-operation unit and a flash emitting section provided in the insertion part are covered with the covering part, and exposed only when the electronic camera is in use.

A digital camera with a slidable display cover provided on a rear surface of a main body is known. The display cover covers a display screen of a reproduction display unit in a first position, and exposes the display screen in a second position (see U.S. Pat. No. 7,057,660). On a front surface of the main body, a lens/flash cover is provided. The lens/flash cover moves in accordance with the display cover. When the display cover is positioned in the first position, the lens/flash cover covers an incident surface of the imaging optical system and a flash emitting section of the main body. When the display cover is positioned in the second position, the lens/flash cover is retracted to expose the incident surface and the flash emitting section. The power of the digital camera is turned on and off in accordance with the operation of the display cover and the lens/flash cover.

The digital camera used as the image viewer or the music player as described above is often unsuitable for carrying, and lacks ease of use compared with devices exclusively used as the image viewer or the music player. In particular, when the digital camera is used as a mobile music player, a user may become less conscious of carrying the digital camera as the user is absorbed in listening to the music, and accidentally touches a taking lens and leave fingerprints and/or extraneous substances on the taking lens.

To solve such problems, the openable cover such as the lens barrier may be provided to cover the taking lens, the viewfinder, and/or the LCD as described in the above references. The cover is closed when the digital camera is used as the music player. However, adding such cover and an open/close mechanism to the digital camera increases the number of parts and complexity in the structure, resulting in cost increase. Moreover, even if the cover is provided, the same problems as the conventional camera without the cover occur if the user forgets to close the cover.

If the lens barrier is provided to the digital camera to cover a taking lens with a lens barrel of a protruding type, an external force is applied to the taking lens when the digital camera is carried, which is not preferable. The external force is not applied to the taking lens with a lens barrel of a non-protruding type or a collapsible type. However, it is necessary to provide a lens barrier which covers the entire front surface of the taking lens including the lens barrel. Accordingly, the size of the lens barrier is increased, resulting in upsizing of the digital camera.

### SUMMARY OF THE INVENTION

In view of the foregoing, a primary object of the present invention is to provide an image capture apparatus which is easy to hold and operate without a lens barrier.

Another object of the present invention is to provide an image capture apparatus capable of securely protecting a taking lens from finger prints and extraneous substances without a lens barrier.

In order to achieve the above and other objects, the image capture apparatus according to the present invention includes a main body and an image display unit. On a front surface of the main body, a taking lens is disposed. On a rear surface of the main body, an operating section for operating the image capture apparatus is disposed. The main body has an image sensor for converting an optical image entered from the taking lens into an image signal. The image display unit is selectably and removably attached to one of the front surface and the rear surface, and displays an image on a display screen on the basis of the image signal.

The main body further includes a detecting section and a limiting section. The detecting section detects whether the image display unit is attached to the front surface or the rear surface. The limiting section identifies an attaching position of the image display unit on the basis of a detected result of the detecting section, and limits selectable operation modes from plural operation modes of the main body on the basis of the attaching position.

When the image display unit is attached to the rear surface, the selectable operation modes include a still image capture mode and a movie capture mode. When the image display unit is attached to the front surface, the selectable operation modes include a music player mode. These operation modes are limited in accordance with the attaching position of the image display unit.

A menu screen for selecting the operation mode is changed in accordance with the attaching position of the image display unit. If there is only one selectable operation mode, the limiting section automatically switches to the selectable operation mode.

The image display unit is capable of covering the taking lens when the image display unit is attached to the front surface. A surface of the image display unit attached to the main body has the same size and shape as the front surface.

The image display unit is attached to a first position to cover the taking lens, or a second position to expose the taking lens, and the image display unit is attached to either of two positions. In the second position, an operation mode of the main body is set to a self capture mode, and an image on the screen is mirror reversed. The image sensor is used for detecting whether the image display unit is in the first position or the second position.

When the image display unit is attached to the rear surface, the image display unit covers a part of the rear surface to expose the operating section to be operable.

A support section is swingably connected to the rear surface, and the support section swings open to keep the main body upright when the image display unit is attached to the front surface.

According to the present invention, the image display unit is selectably and removably attached to one of the front surface and the rear surface of the main body. Therefore, the image display unit can be used as the lens cover when the digital camera is not used for capturing images. Thereby, the taking lens is securely protected from finger prints and extraneous matters. The digital camera is resistant to an external force applied thereto during transportation and carrying. Moreover, since there is no concern for the taking lens, it is easy to hold the digital camera. If the size and the shape of the image display unit are the same as those of the front surface, the digital camera can be held more easily. Since the attaching positions of the image display unit can be changed, the digital camera has good operability. By selectively exposing and covering the operating section in accordance with the attaching position of the image display unit, necessary parts of the operating section in each operation mode become distinct. Accordingly, confusion in operation of the digital camera is eliminated.

Since the operation modes are limited in accordance with the attaching positions of the image display unit, errors in switching the operation modes are reduced.

The attaching positions of the image display unit to the front surface can be switched between the first position to cover the taking lens, and the second position to expose the taking lens. Thereby, the self capturing is facilitated. In the second position, the main body is set in the self capture mode, and the image displayed on the display screen is mirror reversed. Thereby, the user is displayed on the display screen as if the user is looking in a mirror. Therefore, the user does not feel uncomfortable.

If the image sensor is used for detecting whether the image display unit is in the first position or in the second position, increase in the number of parts can be prevented.

The image display unit covers a part of the rear surface to expose the operating section to be operable when the image display unit is attached to the rear surface. Accordingly, an area surrounding the exposed operating section can be used as a grip section to facilitate the holding of the main body. Therefore, operability is enhanced.

A support section is swingably connected to the rear surface. Therefore, the support section is folded at the time of attaching the image display unit to the rear surface, not interfering with the attachment thereof. When the image display section is attached to the front section, the support section swings open to keep the main body upright on a desk or the like with ease.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a perspective view showing a main body and an image display unit constituting a digital camera of the present invention;

FIG. 2 is a perspective view showing a rear surface of the digital camera;

FIG. 3 is a block diagram showing an electric configuration of the digital camera;

FIG. 4 is a perspective view showing a state where the image display unit is attached to the rear surface of the main body;

FIG. 5 is a perspective view showing a state where the image display unit is attached to cover the entire front surface of the main body;

FIG. 6 is a perspective view showing a state where the image display unit is attached to the front surface with a taking lens being exposed;

FIG. 7 is an explanatory view of a first menu screen;

FIG. 8 is an explanatory view of a second menu screen;

FIG. 9 is an explanatory view of a message screen;

FIG. 10 is a perspective view showing a state where a support section is swung open;

FIGS. 11A, 11B and 11C are section views of the main body and the image display unit; and

FIG. 12 is a flow chart showing a main sequence of the digital camera.

### DESCRIPTION OF THE PREFERRED EMBODIMENTS

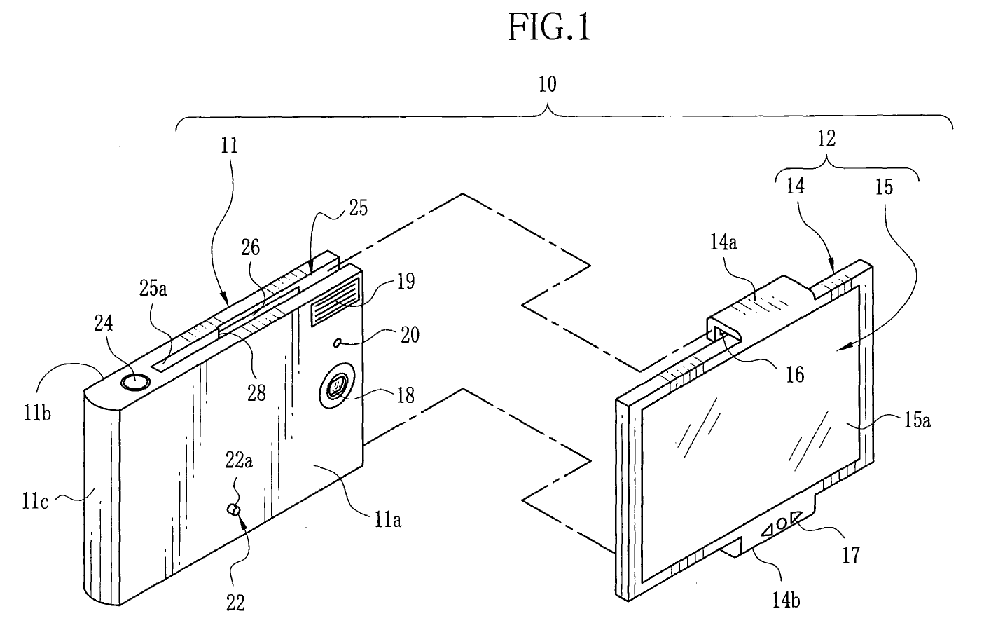

In FIG. 1, a digital camera 10 is constituted of a main body 11 and an image display unit 12 for displaying images. The image display unit 12 is removably attached to the main body 11. The digital camera 10 can be used as an image viewer or a music player with ease and with simple operation by changing the way of attaching the image display unit 12 to the main body 11.

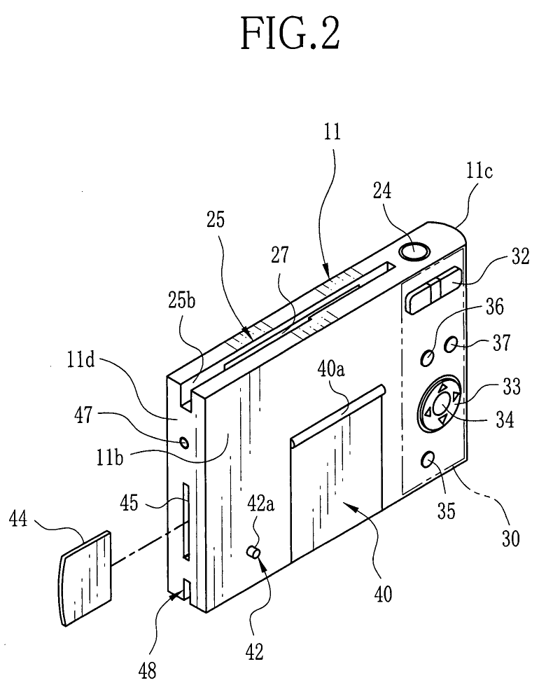

The image display unit 12 has a frame 14 and a liquid crystal display (LCD) 15. The frame 14 has the same rectangular shape as a front surface 11a and a rear surface 11b (see FIG. 2) of the main body 11. The LCD 15 is mounted at the center of one of the surfaces of the image display unit 12. The LCD 15 is used as an electrical viewfinder which displays through images on a screen 15a before an image is captured. The LCD 15 also displays captured images and video images such as TV images transferred to a memory card 44 (see FIG. 2) from a personal computer. Further, the LCD 15 incorporates a touch sensor, and functions as a touch panel. Thereby, the LCD 15 also serves as an operating section used for selecting various operation modes of the digital camera 10.

In an upper portion and a lower portion of the frame 14, L-shaped arms 14a and 14b are formed. With the use of the arms 14a and 14b, the image display unit 12 is attached to the main body 11 in a removable manner. An inner surface beyond a curved segment of the upper arm 14a has a contact 16 (see FIG. 3) which electrically connects the main body 11 and the LCD 15. The lower arm 14b has an operation switch 17 which is used for sequentially forwarding or rewinding a plurality of images displayed on the LCD 15.

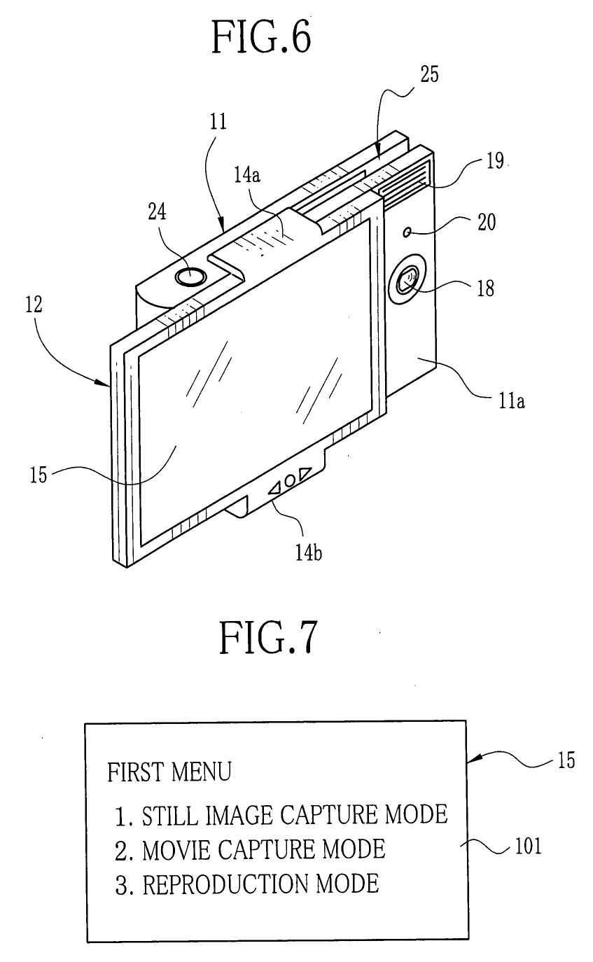

The arms 14a and 14b are formed in positions slightly shifted to the right from a center of the frame 14 in the lengthwise direction, which allows the image display unit 12 to move to a leftmost position and expose a taking lens 18 when the image display unit 12 is attached to the front surface 11a of the main body 11 (see FIG. 6).

The front surface 11a of the main body 11 has the taking lens 18, a flash emitter 19, a light control sensor 20, and a detection switch (SW) 22. The detection SW 22 detects the attachment of the image display unit 12 to the front surface 11a of the main body 11. An end of the detection SW 22, that is, a movable section 22a is protruded from the front surface 11a. When the movable section 22a comes in contact with the image display unit 12 and is pressed down, the detection SW 22 turns on and outputs an ON signal. Note that the taking lens 18, the flash emitter 19, and the light control sensor 20 are placed not to protrude from the front surface 11a so as not to interfere with attachment of the image display unit 12.

On a top surface of the main body 11, a shutter button 24, and a narrow groove 25 extending in a lengthwise direction of the main body 11 are disposed. The shutter button 24 is a touch sensor which turns on the power of the main body 11 in response to a touch. With a half-press of the shutter button 24, AF and auto exposure control (AE) are activated and locked, and by further pressing the shutter button 24, that is, a full press, an image is captured.

The arm 14a is inserted into the groove 25 and engaged therewith. The groove 25 functions as a rail which retains the image display unit 12 in a slidable manner. The groove 25 has an open end on the left-side lateral surface 11d (see FIG. 2), and the arm 14a is inserted into the groove 25 from the open end in a removable manner. In a lower portion of the main body 11, a groove 48 (see FIG. 2) which is paired with the groove 25 is formed. The lower arm 14b is inserted in the groove 48 in a removable manner, and engages with the groove 48. Opposing walls 25a and 25b (see FIG. 2), which constitute the groove 25, have contacts 26 and 27 (see FIG. 2) respectively. One of the contacts 26 and 27 contacts the contact 16 of the arm 14a and is electrically connected thereto. To avoid the complexity in the drawing, each contact 26 and 27 is illustrated as one piece. However, actually, plural contacts compose these contacts. The wall 25a has a step 28 which restrains a position of the image display unit 12 in the lengthwise direction.

Since there is only one position on the rear surface 11b to which the image display unit 12 is attached, as described later, the contact 26 is provided in one area of the wall 25a closer to the lateral surface 11d than the step 28. Since there are two positions on the front surface 11a to which the image display unit 12 is attached, the contact 27 is elongated along the approximately entire length of the wall 25b. A lateral surface 11c of the main body 11 serves as a grip section having a round shape to be easily held by right hand.

As shown in FIG. 2, a zoom button 32, a multi-function cross button 33, a menu/execute button 34, an LCD/return button 35, an image reproduction button 36 and a self timer button 37 are provided in a narrow area 30 shown in imaginary lines. The area 30 is long in the vertical direction on the rear surface 11b of the main unit 11 close to the lateral surface 11c. The menu/execute button 34 is used for selecting an operation mode of the digital camera 10, displaying the menu screen to set various settings in the digital camera 10, and executing selected options. The cross button 33 is used for selecting the items on the menu screen. Since a reproduction mode is frequently used, an image reproduction button 36 is provided exclusively for selecting the reproduction mode. In the case the digital camera 10 is used as a music player, the zoom button 32 is used for adjusting the volume of the music, and the cross button 33 is used for selecting a song title.

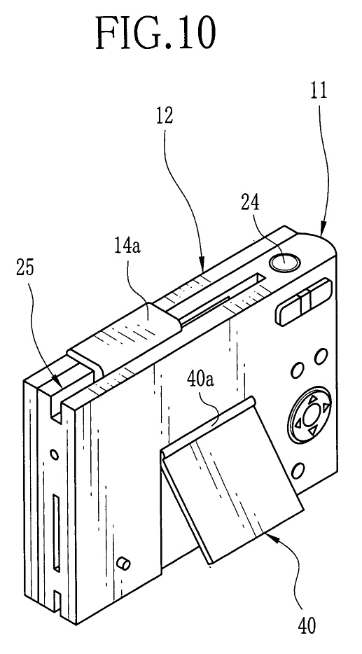

In the center of the rear surface 11b of the main body 11, a support section 40 is attached to rotate around a hinge section 40a so as to keep the digital camera 10 upright like a photo stand (see FIG. 10). Note that the hinge section 40a in the drawing is significantly protruded from the rear surface 11b for the sake of clarity. However, the actual amount of protrusion is so small that it does not interfere with the attachment of the image display unit 12 to the rear surface 11b.

A detection switch (SW) 42 is provided in a lower portion of the left side of the rear surface 11b. The detection switch SW 42 detects whether the image display unit 12 is attached to the rear surface 11b of the main body 11. An end of the detection SW 42, that is, a movable section 42a is protruded from the rear surface 11b. The detection SW 42 turns on and outputs an ON signal when the movable section 42a comes in contact with the image display unit 12 and is pressed down.

A card slot 45, into which the memory card 44 is inserted, and a stereo mini-phone jack 47 are provided on the lateral surface 11d. To use the digital camera as the music player, a connecting terminal of a stereo headphone is inserted into the stereo mini-phone jack 47.

In FIG. 3, a CPU 52 issues commands to a motor driver, which will be described later, and a flash control circuit 57 of a flash device 56 in accordance with various operation signals input from an operating section 54, and controls each section of the main body 11 through a bus 58. The operating section 54 includes the shutter button 24, the zoom button 32, and the cross button 33. The flash control circuit 57 controls emission of the flash emitter 19 in accordance with the output from the light control sensor 20.

The taking lens 18 is constituted of a lens 62 and an aperture stop 63. The lens 62 is constituted of a front lens group acting as a variator lens, and a rear lens group acting as a compensator lens. The lens 62 is driven by a lens drive mechanism 64 having a stepping motor to change an optical zoom magnification and adjust the focus. The aperture stop 63 is driven by an aperture drive mechanism 65 having a motor to change the aperture diameter. The lens drive mechanism 64 and the aperture drive mechanism 65 are driven by motor drivers 66 and 67 respectively. The motor drivers 66 and 67 are controlled by the CPU 52.

At the rear of the taking lens 18, a CCD image sensor (hereinafter simply referred to as a CCD) 70 is disposed. The CCD 70 photoelectrically converts the subject light focused on a light receiving surface through the taking lens 18, and outputs an analog image signal. The CCD 70 has an electric shutter function which performs a shutter release operation in response to the operation of the shutter button 24. The electric shutter function is controlled on the basis of a timing signal (a clock pulse) input from the CCD driver 71.

During the display of the through images, an image signal of a field image (odd or even field image) is read from the CCD 70 and input into an analog signal processing circuit 72. During the image capturing, an image signal of a frame is read from the CCD 70 and input to the analog signal processing circuit 72. The analog signal processing circuit 72 is constituted of a correlated double sampling circuit (CDS) and an amplifier (AMP). The CDS generates analog image signals of red (R), green (G), and blue (B). The AMP amplifies the analog image signals of R, G, and B.

The image signals output from the analog signal processing circuit 72 is converted into the digital image data through the A/D converter 74. Thereafter, the digital image data is stored in an image memory 76 such as the SDRAM through the bus 58. A timing generator (TG) 77 provides timing signals to the CCD driver 71, the analog signal processing circuit 72, and the A/D converter 74 in accordance with the command from the CPU 52, and these components operate in synchronization with the timing signals.

To the bus 58, in addition to the CPU 52, the A/D converter 74, and the image memory 76, an image signal processing circuit 78, a compression/decompression processing circuit 79, a video encoder 80, a media controller 82, an AE detection circuit 84, an AF detection circuit 85, a sound reproduction circuit 86, a unit attachment detection circuit 87, and a counter 89 are connected. To the video encoder 80, the contacts 26 and 27 are connected. To the sound reproduction circuit 86, the stereo mini-phone jack 47 is connected. To the unit attachment detection circuit 87, the detection SW 22 and 42 are connected.

The image signal processing circuit 78 performs various image signal processing such as gradation conversion, white balance correction and gamma correction, and YC conversion to the RGB digital image signals. Before an image is captured in the image capture mode, the through image data (the field image data) input to the image signal processing circuit 78 is subjected to simplified image signal processing and the simplified YC conversion processing, and then temporarily written in the image memory 76.

The image memory 76 has memory areas for two frames of through images, storing two successive field images. The field image is read from one of the memory areas while the next field image is written in the other. The video encoder 80 converts the image data written in the image memory 76 into the composite signals, and displays the composite signals on the LCD 15 as the through image via the contacts 26 and 16, or the contacts 27 and 16 and a control board 88. Further, the operation switch 17 is attached to the control board 88.

At the time the shutter button 24 is fully pressed and the image is captured, the frame image data input in the image signal processing circuit 78 is subjected to the regular image signal processing and the YC conversion processing intended for principal images, and then temporarily stored in the image memory 76. Thereafter, the image data is compressed in the compression/decompression processing circuit 79, and stored in the memory card 44 through the media controller 82.

The AE detection circuit 84 integrates the luminance signal of the image signal, and sends the integral value of the luminance signal to the CPU 52 as light metering data. The AF detection circuit 85 decomposes the image signal into spatial frequency components, and sends contrast data of a high frequency component to the CPU 52. The CPU 52 controls the lens drive mechanism 64 through the motor driver 66, and moves the focusing lens along the optical axis direction to a position where the contrast of the high frequency component of the subject image reaches a highest value.

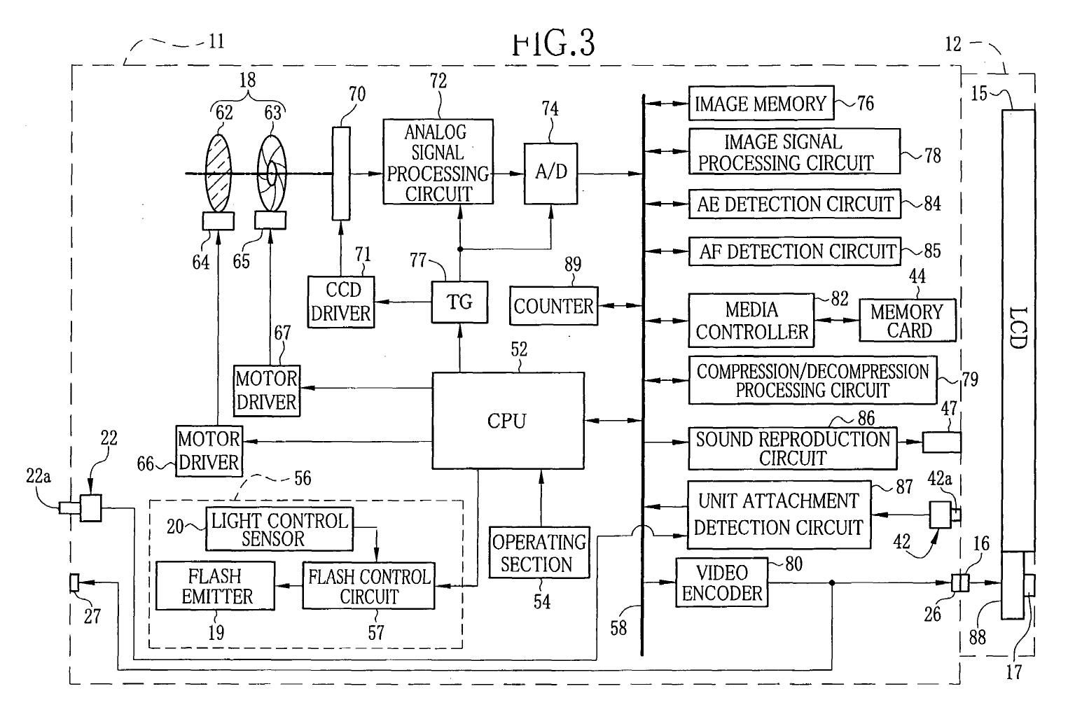

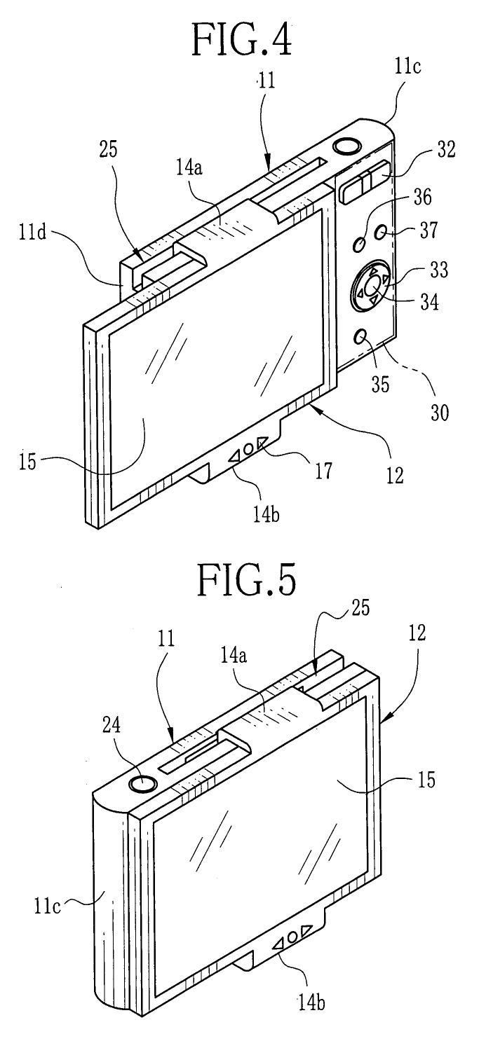

Upon receiving the ON signal output from the detection SW 22 or the detection SW 42, the unit attachment detection circuit 87 detects the attachment of the image display unit 12 and the attached position (the front surface 11a or the rear surface 11b). In accordance with the attached position, the unit attachment detection circuit 87 outputs a front surface detection signal or a rear surface detection signal to the CPU 52. In other words, as shown in FIGS. 5 and 6, when the image display unit 12 is attached to the front surface 11a, the unit attachment detection circuit 87 outputs the front surface detection signal upon receiving the ON signal from the detection SW 22. As shown in FIG. 4, when the image display unit 12 is attached to the rear surface 11b, the unit attachment detection circuit 87 outputs the rear surface detection signal upon receiving the ON signal from the detection SW 42. These detection signals are sent to the CPU 52 through the bus 58.

The CPU 52 identifies the attaching position of the image display unit 12 based on the above two types of the detection signals: the front surface detection signal and the rear surface detection signal. As shown in FIG. 4, there is only one attaching position when the image display unit 12 is attached to the rear surface 11b. When attached to the front surface, on the other hand, the image display unit 12 can stay one of two positions: a front first position (hereinafter simply referred to as a first position) as shown in FIG. 5, or a front second position (hereinafter simply referred to as a second position) shown in FIG. 6. The first position shown in FIG. 5 is a position where the image display unit 12 covers the entire surface of the front surface 11a. In the first position, the image display unit 12 functions as a lens cover to cover the taking lens 18. The second position is a position shifted from the first position toward the lateral surface 11d with a predetermined amount to expose the taking lens 18.

The CCD 70 detects whether the image display unit 12 is attached to the first position or the second position. Since the taking lens 18 is covered when the image display unit 12 is in the first position, and the taking lens 18 is exposed when the image display unit 12 is in the second position, the output of the image signal from the CCD 70 differs in the above two positions. On the basis of the output change, the CPU 52 identifies whether the image display unit 12 is attached to the first position or the second position. More specifically, the CPU 52 identifies the attaching position of the image display unit 12 on the basis of whether the image signal of the field image can be read from the CCD 70.

Thus, the CPU 52 uses the detection SW 22 and 42, the unit attachment detection circuit 87, and the CCD 70 as a detecting section. In accordance with a detection result, the CPU 52 identifies whether the image display unit 12 is attached to one of the above three positions. Then, the CPU 52 limits the selectable operation modes in accordance with the attaching position of the image display unit 12.

As described above, the digital camera 10 has plural operation modes such as the image capture mode in which the digital camera 10 functions as the camera to record the captured image in the memory card 44, the reproduction mode in which the image data stored in the memory card 44 is reproduced and displayed, the image viewer mode, and the music player mode. The image capture mode includes the still image capture mode for capturing the still image, the movie capture mode for capturing the movie, and in addition to these two normal capture modes, a self capture mode as a special capture mode. The self capture mode facilitates to capture an image of the user him/herself by pointing the taking lens to him/herself.

The image viewer mode includes the reproduction mode. In addition, in the image viewer mode, a slide show which automatically reproduces the still images stored in the memory card 44 at predetermined intervals can be performed, and a movie such as TV images transferred from the personal computer to the memory card 44 can be viewed. The music player mode is a mode to reproduce the sound data stored in the memory card 44. The reproduced sound signals are output from the stereo mini-phone jack 47. Thereby, the sound is listened through a stereo headphone connected to the mini stereo jack 47. The sound data is stored in a data format such as MP3.

As shown in FIG. 4, first, if the image display unit 12 is attached to the rear surface 11b, it is assumed that the digital camera 10 is used as the ordinary camera. Therefore, the CPU 52 limits the selectable modes to the still image capture mode, the movie capture mode, and the reproduction mode. More specifically, as shown in FIG. 7, a first menu screen 101 showing only the above three selectable operation modes is displayed on the LCD 15, precluding the operation modes other than the above three operation modes. The operation mode is selected by touching the screen of the LCD 15 with a finger, or by operating the cross button 33.

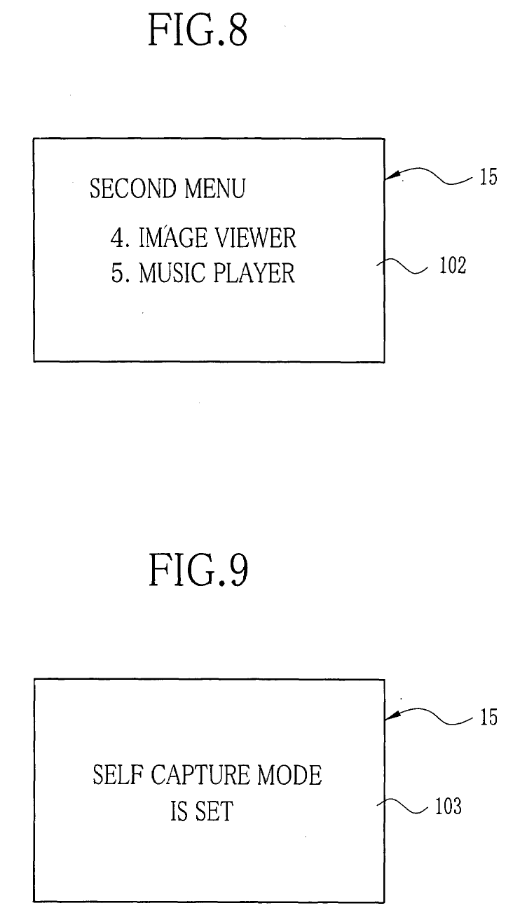

Next, as shown in FIG. 5, if the image display unit 12 is attached to the first position of the front surface 11a, the taking lens 18 is covered so that the image cannot be captured. Accordingly, the CPU 52 limits the selectable operation modes to the image viewer mode and the music player mode. As shown in FIG. 8, the CPU 52 displays a second menu screen 102 showing only the above two operation modes on the LCD 15. In the image viewer mode, the display image can be forwarded or rewinded with the operation of the operation switch 17.

Lastly, as shown in FIG. 6, when the image display unit 12 is attached to the second position of the front surface 11a, the taking lens 18 is exposed. Since the taking lens 18 and the LCD 15 point at the same direction, the image of the user can be easily checked. Owing to this advantage, the CPU 52 limits the selectable operation mode to the self capture mode. When the image display unit 12 is set in the second position, the CPU 52 automatically switches the mode to the self capture mode, and displays a message screen 103 which indicates the self capture mode is set on the LCD 15 for a predetermined time, for instance, five seconds. Thereafter, a through image of the user captured through the taking lens 18 is displayed on the LCD 15. The through image displayed on the LCD 15 is, for instance, mirror reversed like a mirror image. The image is not necessarily reversed in the horizontal direction for the display. However, by displaying the mirror reversed image, the LCD 15 can also be used as a mirror.

If the image display unit 12 is attached to the front surface 11a, as shown in FIG. 10, the support section 40 provided on the rear surface 11b is swung open to keep the main body 11 upright on a desk or the like. With the full press of the shutter button 24 after the self timer button 37 is pressed, the counter 89 starts to count down.

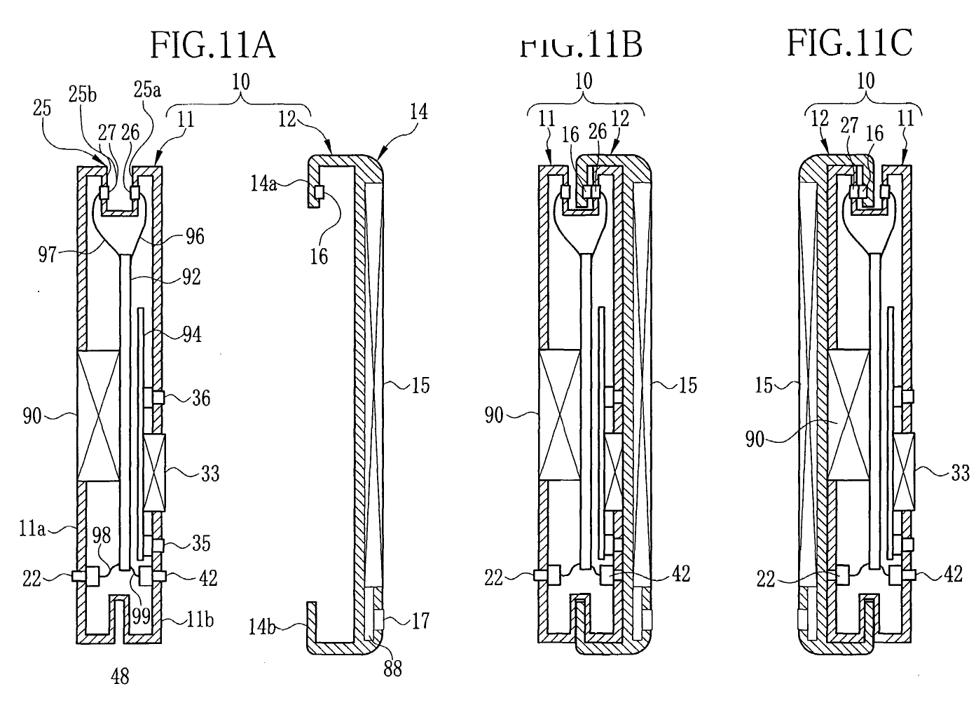

In FIGS. 11A to 11D, most of the parts including the CPU 52, and an image capture unit 90 constituted of the taking lens 18 and the CCD 70 are mounted on a main board 92, and fixed inside the main body 11. An operation board 94 is provided adjacent to the main board 92. The operation buttons such as the cross button 33 and the LCD/return button 35 are mounted on the operation board 94.

The contacts 26 and 27 provided on the walls 25a and 25b are connected to the main board 92 through the wires 96 and 97 respectively. The detection SW 22 of the front surface 11a and the detection SW 42 of the rear surface 11b are connected to the main board 92 through the wires 98 and 99 respectively.

As shown in FIG. 11B, when the image display unit 12 is attached to the rear surface 11b, the movable section 42a is pressed by the image display unit 12, turning on the detection SW 42. At the same time, the contact 16 comes in contact with the contact 26. As shown in FIG. 1C, when the image display unit 12 is attached to the front surface 11a, the movable section 22a is pressed by the image display unit 12, turning on the detection SW 22. At the same time, the contact 16 comes in contact with the contact 27.

An operation of the above embodiment is described. To use the digital camera 10 as a camera, as shown in FIG. 4, the image display unit 12 is attached to the rear surface 11b of the main body 11. The arms 14a and 14b are inserted into grooves 25 and 48 from the lateral surface 11d, and the image display unit 12 is slid toward the lateral surface 11c. An end of the arm 14a comes in contact with the step 28 formed on the wall 25a, which blocks the slide movement of the arm 14a. Thereby, the image display unit 12 is attached to the rear surface 11b with the area 30 being exposed, and the contact 16 contacts with the contact 26. Accordingly, the operating section 54 is operated without any trouble, and the lateral surface 11c can be used as the grip section.

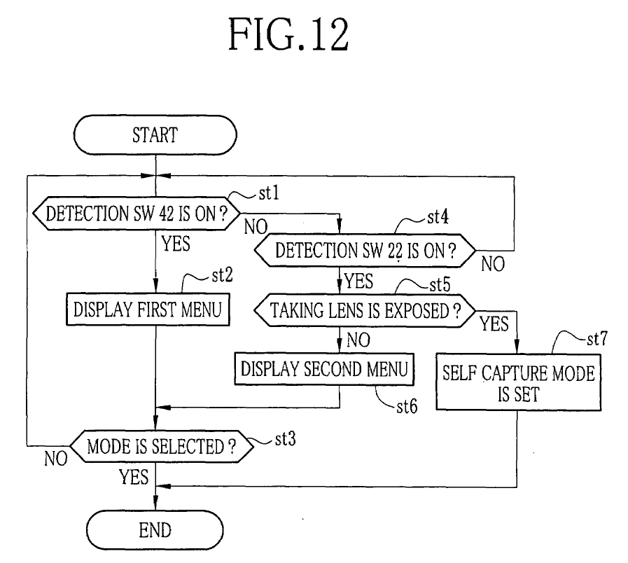

The power of the main body 11 turns on upon a light touch to the shutter button 24. As shown in the flowchart of FIG. 12, the movable section 42a is pressed by the image display unit 12, turning on the detection SW 42 (st 1). Thereby, the rear surface detection signal is input from the detection SW 42 to the CPU 52, indicating that the image display unit 12 is attached to the rear surface 11b.

As shown in FIG. 7, only the first menu screen 101 is displayed on the LCD 15 (st 2) and other menu screens are not displayed. Accordingly, the selectable modes are limited to the still image capture mode, the movie capture mode, and the reproduction mode. The touch sensor is provided on the surface of the LCD 15. Upon a touch to one of the still image capture mode, the movie capture mode, and the reproduction mode, the touched mode is selected (st 3).

When the image display unit 12 is attached to the first position shown in FIG. 5, the contact 16 contacts the contact 27, and the detection SW 22 is turned on (st 4). Since the taking lens 18 is not exposed (st 5), as shown in FIG. 8, the second menu screen 102 is displayed on the LCD 15 (st 6). At this time, menu screens other than the second menu screen 102 are not displayed on the LCD 15. Accordingly, the selectable modes are limited to one of the image viewer mode and the music player mode. Upon the touch to one of the image viewer mode and the music player mode, the touched mode is selected (st 3).

Thus, in the image viewer mode and the music player mode, the taking lens 18 is completely covered with the image display unit 12 without the use of the lens barrier. As a result, the digital camera 10 resistant to the external forces during the transportation and carrying is achieved, and the taking lens 18 is protected from fingerprints and the extraneous substances without the cost increase.

As shown in FIG. 6, when the image display unit 12 is slid along the groove 25 from the first position toward the lateral surface 11c and set in the second position, the taking lens 18 is exposed. Thereby, the detection SW 22 turns on (st 4), and the taking lens 18 is exposed (st 5), so that the CPU 52 sets the mode in the self capture mode (st 7). At the same time, as shown in FIG. 9, the CPU 52 displays a screen 103 indicating “self capture mode is set” for 5 seconds, for instance, and then displays the mirror reversed through images.

Upon the full press of the shutter button 24 after the self timer button 37 is pressed, the counter 89 starts to count down. The LCD 16 displays a count down display which sequentially displays the numbers, for instance, from 10 to 0 at intervals of one second.

In the above embodiment, in the case the image display unit 12 is attached to the rear surface of the main body, the entire operating section on the rear surface is exposed. It is also possible to cover a part of the operating section with the image display unit 12. For instance, the image display unit can be attached to the rear surface, covering a part of the operating section used only in the image viewer mode and the music player mode to prohibit the operation thereof. This part of operating section is exposed when the image display unit is attached to the front surface, and therefore the operation thereof is allowed. Thus, the necessary part of the operating section is exposed in accordance with the attaching position of the image display unit.

In the above embodiment, the LCD is a touch sensor-type, and operation modes are selected upon a touch of a finger on the LCD. However, the present invention is not limited to the above. It is also possible, for instance, to display a cursor on the screen. This cursor is moved by the operation of the cross button or the like to a desired mode, and then the menu/execute button is pressed to select the mode.

In the above embodiment, the display indicating that the digital camera is set in the self capture mode is displayed for 5 seconds. However, the present invention is not limited to the above. The display can be displayed, for instance, for 2 seconds or 10 seconds. Further, in the above embodiment, the taking lens is not protruded from the main body 11. It is also possible to use a taking lens of a collapsible type. In this case, a sensor is provided close to the collapsible taking lens so that the taking lens is controlled to automatically collapse at the time of attaching the image display unit to the main body.

In the above embodiment, the three attaching positions of the image display unit in total are described as an example: one in the rear surface and two in the front surface. The number of the attaching positions is not necessarily three. It is possible to provide two attaching positions in total: one in each of the front and the rear surfaces. Further, in the above embodiment, two attaching positions of the front surface are detected with the use of the CCD. However, instead of using the CCD, it is also possible to increase a part similar to the detection SW in accordance with the attaching position.

In the above embodiment, a section of the groove has a rectangular shape. It is also possible to make the groove having a T-shaped section like a rail. In the above embodiment, the image display unit has arms and the main body has a long groove for the attachment, and the arms are inserted from an end of the groove and slid therethrough. However, the present invention is not limited to the above. For instance, it is also possible to form the arm with an elastic material, and provide a concave section in the main body instead of the groove, and bend and insert the arm into the concave section.

In the above embodiment, the attachment of the image display unit is detected by on/off of the detection SW. It is also possible to detect the attachment by detecting changes in resistance of the contact. Further, the present invention is applied to the digital camera in the above embodiment. It is also possible to apply the present invention to image capture apparatuses such as a mobile phone with a camera and a PDA with a camera.

As described so far, the present invention is not to be limited to the above embodiments, and all matter contained herein is illustrative and does not limit the scope of the present invention. Thus, obvious modifications may be made within the spirit and scope of the appended claims.

What is claimed is:

1. An image capture apparatus comprising:
a main body including:
a front surface on which a taking lens is disposed;
a rear surface on which an operating section for operating said image capture apparatus is disposed;
an image sensor for converting an optical image entered from said taking lens into an image signal; and
an image display unit selectably and removably attached to one of said front surface and said rear surface for displaying an image on a display screen on the basis of said image signal.

2. An image capture apparatus according to claim 1, said main body further including:
a detecting section for detecting whether said image display unit being attached to said front surface or said rear surface; and
a limiting section for identifying an attaching position of said image display unit on the basis of a detected result of said detecting section, and limiting selectable operation modes from plural operation modes of said main body on the basis of said attaching position.

3. An image capture apparatus according to claim 2, wherein when said image display unit is attached to said rear surface, said selectable operation modes include a still image capture mode and a movie capture mode, and when said image display unit is attached to said front surface, said selectable operation modes include a music player mode, and these operation modes are limited in accordance with said attaching position of said image display unit.

4. An image capture apparatus according to claim 2, wherein a menu screen for selecting said operation mode is changed in accordance with said attaching position of said image display unit.

5. An image capture apparatus according to claim 2, wherein if there is only one selectable operation mode, said limiting section automatically switches to said operation mode.

6. An image capture apparatus according to claim 1, wherein said image display unit is capable of covering said taking lens when said image display unit is attached to said front surface.

7. An image capture apparatus according to claim 6, wherein a surface of said image display unit which is attached to said main body has the same size and shape as said front surface.

8. An image capture apparatus according to claim 6, wherein attaching positions of said image display unit to said front surface include a first position to cover said taking lens, and a second position to expose said taking lens, and said image display unit is attached to either of said two positions.

9. An image capture apparatus according to claim 8, wherein in said second position, said main body is set to a self capture mode, and an image on said display screen is mirror reversed.

10. An image capture apparatus according to claim 8, wherein said image sensor is used for detecting whether said image display unit is in said first position or said second position.

11. An image capture apparatus according to claim 1, wherein said image display unit covers a part of said rear surface to expose said operating section to be operable when said image display unit is attached to said rear surface.

12. An image capture apparatus according to claim 1, wherein a support section is swingably connected to said rear surface, and said support section swings open to keep said main body upright when said image display unit is attached to said front surface.
